(19) United States
(12) Patent Application Publication
(10) Pub. No.: US 2008/0084872 A1
(43) Pub. Date: Apr. 10, 2008

(54) SYSTEM FOR PROVIDING CONTENT AND COMMUNICATION SERVICES

(76) Inventors: Ruqian Li, Raleigh, NC (US); Dong Zhou, Cary, NC (US); Julie Dyrdek Broad, Chapel Hill, NC (US)

Correspondence Address: PASSE' INTELLECTUAL PROPERTY, LLC, 1717 BRASSFIELD RD., RALEIGH, NC, 27614, US

(21) Appl. No.: 11/756,581

(22) Filed: May 31, 2007

Related U.S. Application Data
(60) Provisional application No. 60/850,385, filed on Oct. 10, 2006.

(51) Int. Cl. H04L 12/66

(52) U.S. Cl. 370/352

(57) ABSTRACT

The present invention relates to methods and systems of using removable memory media to provide a means for initiating a communication session on a computer device over the internet and providing static and dynamic content to the computer device without the need for the computer to configure the software nor require resident software on the computer wherein selected dynamic content can be delivered to the computer device in accordance with selected customer parameters.

This application claims priority of U.S. application Ser. No. 60/850,385 filed on Oct. 10, 2006 and incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to methods and systems for providing static and dynamic content to a selected computer device along with communication services. In particular, the present invention relates to methods and systems of using removable memory media to provide a means for initiating a communication session on a computer device over the internet and providing static and dynamic content to the computer device without the need for the computer to configure the software nor require resident software on the computer wherein selected content can be delivered to the computer device.

2. Description of Related Art

In the internet multimedia communications field of providing communications over the internet (including voice, video and data) such as IP telephony, instant messaging, video conferencing and the like, a number of challenges exist in providing service over a personal computer or other computer device interfacing with the internet. Multimedia communications over the internet normally use an Internet Protocol network of Internet connectivity. The internet has proliferated to a global user base, and this user base is now being used to route calls such as telephone calls to PSTN standard switching stations on a local basis thus saving users millions of dollars in long distance calls. A client can initiate a call over the internet and a multimedia communications provider such as a voice over the internet protocol (VoIP) provider receives the call at their server and routes it to the telephone line, cell or other standard based communication system.

At the present there are only two approaches to delivering such a service. The first way that service is delivered is exemplified by the most common methods used by IP telephony. In this method, a customer signs up with a VoIP provider and downloads software to his computer hard drive. An IP communications device (such as a VoiP phone) or the like can begin to operate after execution and configuration of the resident software. Personal security codes or authorization codes are either loaded into the software or executed by the customer each time a call is to be made. A billing account is established and either communication minutes are prepaid or the client receives a periodic bill in order to continue the service. The installation of the software enables the client's computer or other device to interact with the specific and dedicated communications provider and obtain access to the communications service over the PSTN.

The need to install software on a computer and to require the computer to configure it is a particularly difficult problem. It means that a copy of the software must be installed on each and every computer that one wishes to use to communicate using the communication service provider. Where the customer needs to use an airport computer, a mall computer, a friend's computer, any computer not his own or the like, the downloading of software on the computer may be inconvenient if not impossible. Since these types of software often operate to exclude other communications software, it is also not practical to have multiple communications software on the same computer. It is further a problem that when one service provider is used for multimedia communications, the connection to various points is only as good as the connections to that point of the particular provider. This is true even though one provider may be better than another to one location and the reverse true to another point of communication. Even further once a particular provider is chosen the customer is stuck with the rates charged by that provider even if a different provider would offer a better price.

A second way that multimedia communications is handled is by use of a system which is implemented via an Internet web page or a web server. The problem of resident software has been recognized by those in the internet multimedia communications art and some solutions to overcome these problems have been attempted. In U.S. Pat. No. 6,791,974 to Greenberg issued Sep. 14, 2004 there is disclosed an internet based telephony system accessible via an internet web page and controlled by a Web server. The user is required to have a Java enabled internet browser and must download an applet to the computer in order to make a call. Also, the client must enter data fields regarding the account number and codes in order to operate the web site or have the information on the computer which must be configured before it can be given to the provider on the web site. This does allow someone with access to almost any computer to make calls but still requires a specific type of browser and the ability to accept applets which borrowed or community computer sites usually do not allow. Once implemented, the user can make calls to any phone and is billed accordingly. There is no need to download any software though in this particular method but it still suffers from single provider problems, software execution, and configuration. It also requires input from the customer and as noted requires an internet browser and cannot directly connect via IP addresses.

The '974 patent also teaches pushing of web pages to the particular user through the browser resident VoIP or other application using dial pad sequences on their telephone CC1 or similar telephony device. There is no interactive process and the “push” occurs to all users regardless of who they are. In addition, if a particular computer has blocked access to particular web sites such as the case with mall computers and the like, access to a particular web site might be impossible and a browser may have limitations.

It would be useful if the problems of computer based and web based multimedia communication could be overcome and provide an alternate means for using a wide variety of computer devices as well as provide a tool for marketing services and content.

### BRIEF DESCRIPTION OF THE INVENTION

The above described problems and more appear to be solved by the present invention. Generally, a system of using multimedia communication as a means for delivering static and dynamic content to a customer is disclosed herein removable media is used to deliver content without the need to configure software on the computer or have resident software or other resident programs located on the hard drive.

The present invention provides a customer with prepaid or free multimedia communication software on a removable multimedia source such as a CD or DVD or the like. In opening the multimedia communications software static and dynamic content can be delivered to the customer based on desired parameter obtainable from customer activity, customer input customer location, and the like.

A further benefit of the invention is the ability to select the best communications service provider for the customer at the time of the communication. This could be decisions based on location, quality of transmission, price, or any other measurable parameter for providing service.

Accordingly one embodiment of the invention relates to a system enabling a customer to initiate internet media communication and interact with selected static or dynamic multimedia content over any computer device comprising:
a. a removable memory media comprising multimedia communication software and a media identification code wherein the software is capable of self executing, self configuring and sending the media identification code to a selected authentication server;
b. an authentication server capable of identifying the media identification code, profile matching the computer device and selecting a communication service provider for that location, wherein the authentication server is capable of sending the computer device authorization to engage in a communication event with the selected provider;
c. a session controller capable of initializing, monitoring, and controlling the communication event by the customer; and
d. a means for presenting the customer multimedia content on a graphic interface on the computer device from the group consisting of static content and dynamic content.

These and other objects of the present invention will be clear to one skilled in the art when taken in view of the detailed specification and disclosure in conjunction with the appended figures.

### BRIEF DESCRIPTION OF THE DRAWINGS

FIG. 1 is a block diagram of the overall architecture of an embodiment of the invention wherein the communication channel is the PSTN network.

FIG. 2 is a flow diagram of the general operational steps taken by the present invention when using IP telephony as the communication system.

FIG. 3 is a screen shot of static content on the removable media which as self executed along with a tab for a second “phone” page.

FIG. 4 is an IP phone page of the present invention wherein a GUI phone interface is displayed along with static content from the removable media.

FIG. 5 is the same phone page from FIG. 4 however the static content has been replaced by dynamic content from the content server after a successful login.

FIG. 6 is a flow diagram that depicts the authorization, authentication and service selection process of an embodiment of the invention.

### DETAILED DESCRIPTION OF THE INVENTION

While this invention is susceptible of embodiments in many different forms, there is shown in the drawings and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes specific embodiments shown in the figures in order for those skilled in the art to practice the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

As used herein “internet media communication” refers to any communications means between one IP address and one or more other IP addresses that occur with at least a portion of the communication transmitted over the internet. Examples include IP telephony, instant messaging, video conferencing, point to point communication, dedicated T1 lines and the like. File transferring, application sharing. As used herein “multimedia communication software” refers to any software designed to conduct internet media communication that will be used by an individual customer of the communication service.

As used herein “multimedia content” refers to any method of presenting communication including web pages, video, voice recording, text and the like. It can be in the form of an advertisement, message, survey, story, news, contact information, catalog, event schedules, relevant information and the like. As used herein “static multimedia content” refers to multimedia content that is resident in software or in removable media such that it is present and can be utilized or displayed when using particular software (See figures for particular examples). Static infers that the content does not change and is always present on a computer device unless the memory media containing it is replaced. “Dynamic multimedia content” on the other hand, refers to content provided a customer that can be changed by a third party provider. While the types of media and the formats are the same the difference is that dynamic media is provided at a particular time and hence can change based on what the provider is sending and not what is resident on a particular memory media.

As used herein “customer” refers to an individual who would be using the system of the present invention and using the internet media communication. This could be someone who purchases the system but in some cases someone who has been given the system of the present invention memory media. Where the static and dynamic content provider is giving the media to a customer, the communication ability and even free communication time is an incentive to view the accompanying static or dynamic content.

As used herein “computer device” refers to any device capable of running multimedia communication software, communicating over the internet using the software, capable of displaying static or dynamic content and capable of accepting removable memory media. In most cases this would refer to a standard desktop or laptop computer. However devices such as PDA's, internet VoIP phones, Digital Video Recorders, Game machines, special computing devices and the like, can in some instances meet these criteria.

As used herein “removable memory media” refers to computer storage media that is capable of being inserted into a computer device and capable of having multimedia communication software and a media identification code that can execute on the particular computer device. This would include in one embodiment devices intended to easily be inserted and removed such as CDs, DVDs, memory cards, memory sticks, and the like. In another embodiment it would include computer devices with built-in reusable memory and the like that are designed to permanently reside inside the computer such as removable hard drives and resident memory. A media identification code is a particular code that identifies the removable memory media as a unique media. The code can then be compared with any other information as the media is used and information transmitted to the provider of the media.

As used herein, “self executing and self configuring” refers to the fact that the software that is contained on the media is such that it will not need to load anything onto the computer device hard drive. Thus, the program may run and configure itself for use on the computer device merely by loading itself directly in the transient memory of the computer device upon inserting the memory media into the computer device.

As used herein a “media identification code” refers to a piece of digital information, data or the like on the removable memory media that identifies the particular removable memory media and hence identifies the particular customer or at least identifies the use of the media. The identification code is designed to let the authentication server keep track of the use of the memory media as well as keep track of information that would aid in providing the customer dynamic content. It can also be used to match the available minutes that the particular media has associated with it in order to determine how much communication time is available to the customer using the memory media.

As used herein “authentication server” refers to a computer which can match the authentication code to information stored on the authentication server about the use, user etc of the particular memory media. This information could for example, be stored in a database on the server and then be recalled when the customers media identification code is sent to the authentication server. By “selected” as used herein refers to the fact that the identification code is sent to an authentication server associated with the memory media, wherein such association is normally set up and decided by the provider of the memory media to a customer. The memory media already will have predetermined information of where to send the identification code. This can be a particular server, one of many, or based on any predetermined criterion that operates the system.

As used herein “profile matching” refers to the authentication server, user of the system or the like obtaining data regarding the user of the communication memory media, especially data that can be used to determine a particular type of dynamic content to send the customer. So, for example, the authentication server could determine the location of the computer device (such as by identifying the IP address of the computer), customer preferences and customer attributes. This could be done by monitoring web sites visited, collect information about the interaction of the static and dynamic content, information and data about the communications made using the multimedia communication software and the like. This information and data could then be information that is used to tailor dynamic content to the customer. For Example, the location could be used to send advertisements from local advertisers, information about political candidates that relates to the particular state they are in and the like. Where communications are monitored dynamic content could relates to the type of business contacted so where the customer has made an IP phone call to a restaurant advertisements for other restaurants, things to do after a night out and the like could be sent by way of dynamic content. Where a Chinese restaurant was called dynamic content regarding other things Chinese could be sent and the like. There is no particular limit to what could be matched. In addition profile matching could obtain information about the customer when he receives the memory media. Where the media is given away free for example, free communication software as a means for delivering the content, the location that the media is picked up could be used. Also, information could be collected directly from the customer in person or over a user interface on the computer and that information used to deliver the dynamic content. One skilled in the art therefore once understanding the idea of the profile matching and delivery of dynamic content could accordingly modify the content as necessary and within the scope of the present invention.

In order to control the use of the communication software to engage in communications which presumably would cost, the authentication server also monitors the available communication time or other parameters which the customer is entitled to use with the communication software. An example would be the memory media allows the customer 25 minutes of communication time. The amount of minutes would be assigned to the media identification code either on the memory media or stored on the authentication server. The amount of time or other criteria could be modified by paying for more time or as a reward for interacting with the static or dynamic media provided to the customer by a provider. After the authentication server determines that the customer is entitled to a certain amount of communication, the authentication server picks a communication service provider such as a PSTN provider of VoIP. This can be done by any desired criteria such as distance from the computer device, cost of the service from the provider and the quality of the available providers of service. The service provider can either be run by the system operator or independent of the system operator and sends an authorization to engage in a communication event with the provider. The authorization is in the form of code or the like that would normally be used with a provider such as a VoIP provider prior to making a call.

As used herein a “session controller” is another server, the authentication server or other means for monitoring and controlling the communication event. It initializes, monitors, controls the communication session between the customer and the communication service provider. So where a certain number of minutes are allowed the session controller limits the communication to the amount of time allowed. The present invention has as one embodiment of its use the ability to give way the memory media with a certain amount of free communication associated with the particular memory media. Because there can be dynamic content such as advertisements or a message the person using the free communication minutes will be exposed to the content, both static and dynamic of the free communication time. Even if the media times is otherwise paid for, the provider of the software can use the present invention to deliver a selected message. And in particular embodiments the message can change as the dynamic content is changed by any criteria established by the provider of the content to the customer.

As used herein, means for presenting the customer content will take the form of both static and dynamic content. The static content would be on the memory media and presented to the customer upon using the software. It would be on separate presented pages or on the communication page. It also refers to the ability when the software connects to the authentication server for a “content server” to download dynamic content to the computer device as previously described. The figures which follow will describe an embodiment of this process which will further clarify the scope intended by the present invention. The dynamic content could be on a separate page or could replace the static page when received.

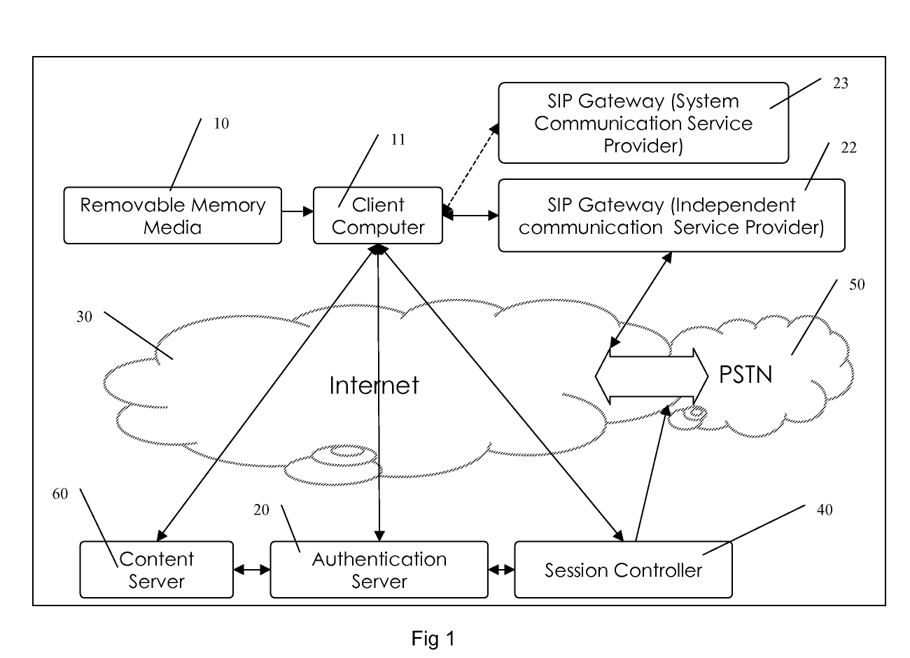

Now referring to the drawings, FIG. 1 is a block diagram of the overall architecture of an embodiment of the invention wherein the communication channel is the PSTN network 50. In this embodiment, a removable memory media 10 is inserted into a selected computer device, in this embodiment, a client computer 11. The removable memory media 10 will have software for executing a communication event and an authorization code to communicate with authentication server 20 over the internet 30. The authentication server will then validate the authorization code it receives, and if there is communication time left send in return to the client computer 11 authorization codes to engage in a communication event with a communication service provider.

The authentication server 20 selects from any number of PSTN providers and in the particular embodiment there is shown an independent service provider 22 and a system communication service provider 23. The system communication service provider 23 is an embodiment where the system of the present includes the communication provider and not an independent one. The authentication server can use any one of desired criteria to determine which provider to authenticate with the client computer 11. This is true no matter how many providers there are but the present invention has the advantage that when multiple providers are available the best provider either for cost or quality of connection or the like can be chosen as previously described.

Once the client computer 11 is communicating with either the system communication service provider 23 or the independent communication service provider 22 a connection can be established with the PSTN 50 over the internet 30 and the connection used in this embodiment to place a phone call to a land line or a cell based phone or any other device with a dedicated phone number. During the authentication process by the authentication server 20 the amount of time the client is allowed to use the communication service provider (22 or 23) is determined. The Session controller 40 then monitors the activity of the client computer 11 over the PSTN 50 and cut off the communication link to the PSTN 50 at the appropriate time either with or without warning beforehand.

The content server 60 regulates the dynamic content on the client computer 11. When the client computer 11 opens the software on the removable memory media 10 it will open not only the communication software but static content for example adds or information, phone numbers or the like as determined by the provider of the system to the customer. The content server 60 can take parameters to profile match the customer with content it has available and deliver dynamic content to the client computer 11 as desired by the determined criteria of the profile matching effort or provide random content that changes as desired. In one embodiment on this invention the amount of time available for communication will be increased when the customer interacts with the static or dynamic software provided to the client computer 11.

While in the embodiment show the authentication server, session controller, and content server are shown as different devices they may exist on the same computer and likewise it may take more than one computer linked together to perform the function of any one of these devices.

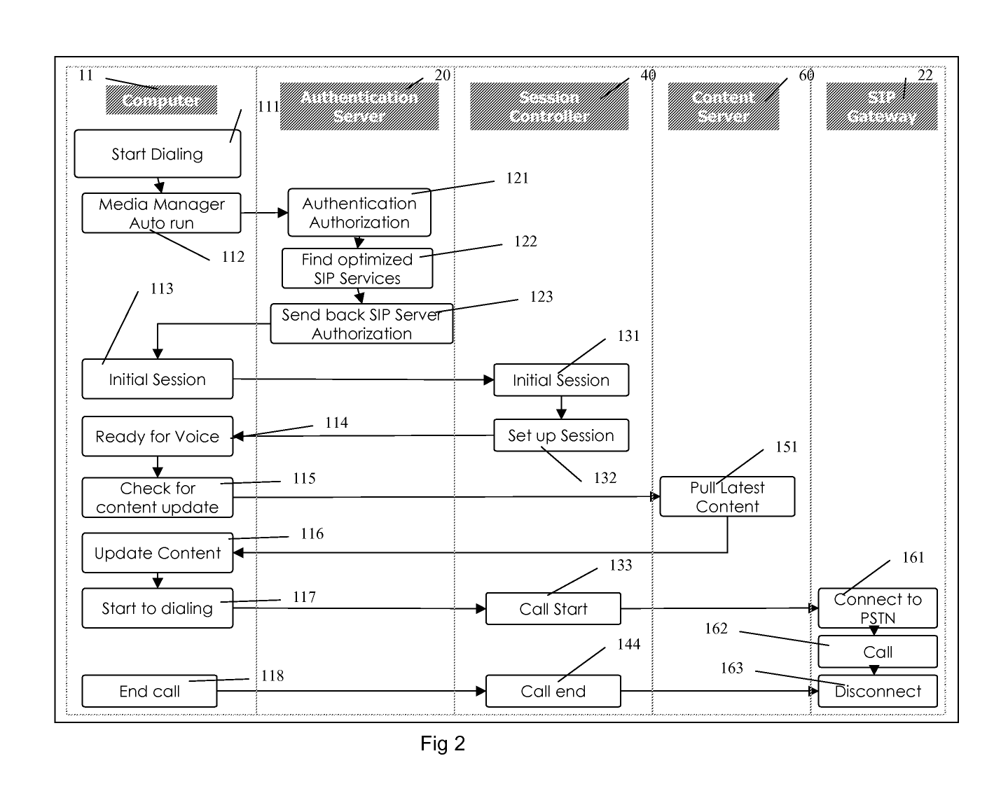

FIG. 2 is a flow diagram of the general operational steps taken by the present invention when using IP telephony as the communication system. The first step is the insertion of the memory media into a client computer 111. The insertion into the client computer initiates the media manager to automatically run 112. The software then loads a GUI for the customer to interact with, on the client computer 11 and also searches out the internet or the like to find the authorization server. Once the authentication server 20 is reached, the authentication server 20 identifies the media memory running on the client computer 11, authorizes a particular amount of connect time and then finds optimized SIP services 122. Once the communication (SIP) services provider is determined the authentication server 20 sends back SIP server authorization 123 to the client computer 11.

The client computer 11 then sets up an initial session 113 for communication with an initial session 1131 on session controller 40. The session controller sets up the communication session 132 and lets the computer 11 know everything is ready in this embodiment for voice communication 114. Once that has been accomplished the computer 11 checks the contents for content update 115 with the content server 60. By comparing the profile of the customer the content server can match available content and pull the latest content 151 and send it back to the computer 11 in order to update content 116 on the computer 11. At that point the computer can dial 117 the particular desired number either from a button on the static or dynamic content or by dialing on a dial pad provided on a GUI. The session controller 40 then stats the call 133 through the communication provider 22 which then connects to the PSTN 161 to establish call 162.

When the customer decides to end call 118 the customer sends data by a button press, the action of the session controller or the like and the call is disconnected 163.

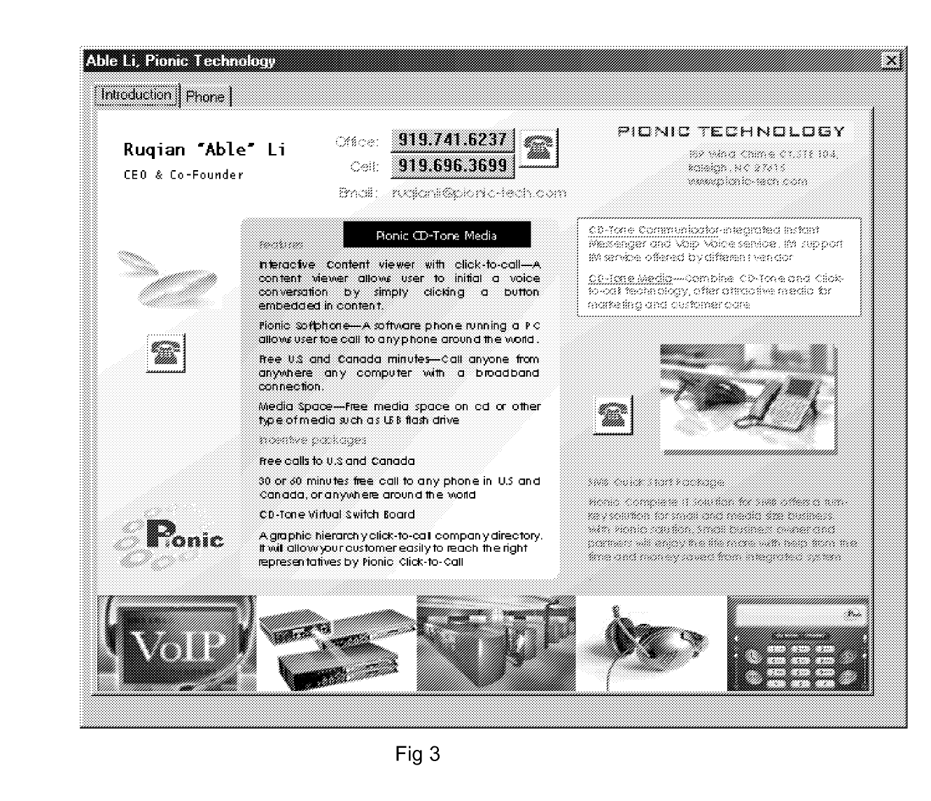

FIG. 3 is a screen shot of static content on the removable media which is self executed along with a tab for a second “phone” page. The page has sever features which load when the communication software auto loads into the client computer 11 from FIG. 1. The static content on this page is on the removable memory media and loads every time the software loads. It has information, buttons for automatically making free phone calls to specific numbers for example to get more information about the static content but can have any other type of executable or non-executable information on the page. It also will have a page tab to provide access to a GUI for the communications which in this embodiment is phone service.

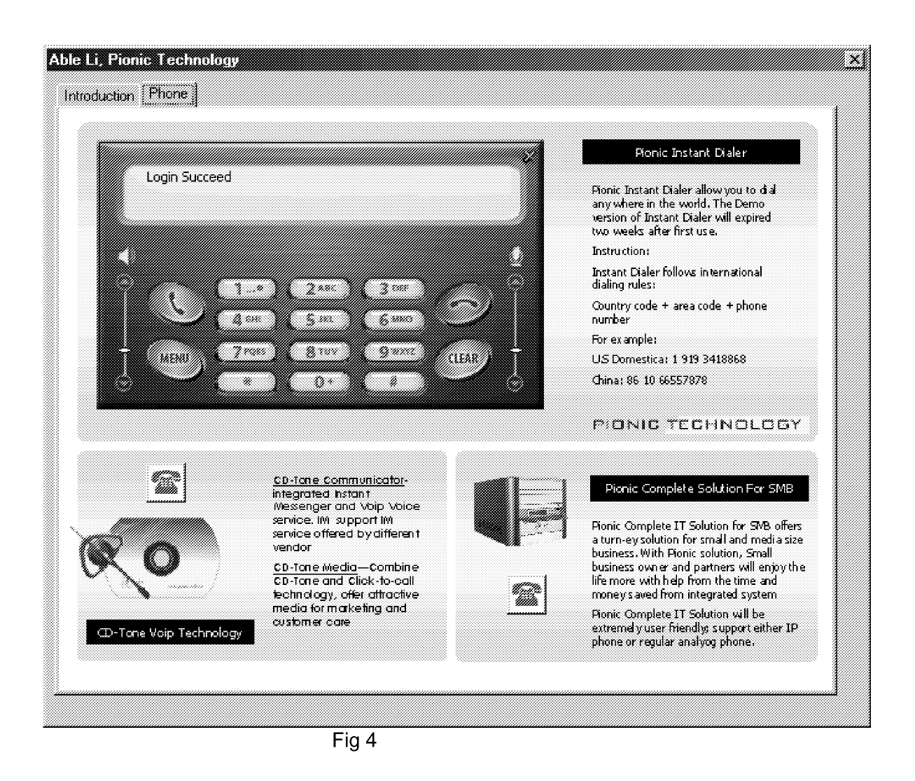

FIG. 4 is an IP telephony phone screen shot page of the present invention wherein a GUI phone interface is displayed along with static content from the removable memory media. Shown in this screen is a phone dialer with more data and phone dialing buttons to reach certain phone numbers represented as phone icons. IN this embodiment information regarding communication services is displayed as an example. The phone GUI also indicates that the client computer 11 has successfully received authorization from the authentication server 20.

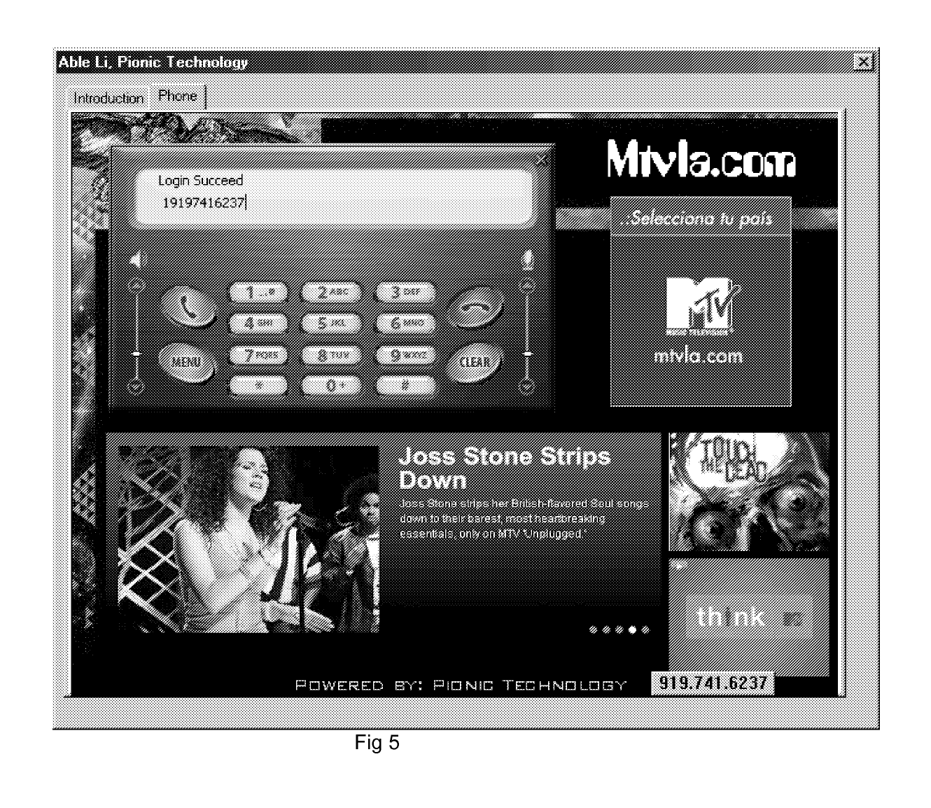

FIG. 5 is the same phone GUI page from FIG. 4 however the static content has been replaced by dynamic content from the content server 60 after a successful login and as the customer has entered a phone number to dial. As can be seen from this screen shot the content has changed to a musical content which could have been decided on the customers preferences or based on the phone number dialed or any criteria that the system provider decides.

It should be noted that one advantage of the present invention is that while one could use an internet browser to connect to the various parties the present invention can connect using a protocol which uses just each piece of the systems computer IP address. There is thus no need to rely on a particular internet browser or for that matter any browser what sever so that the system can be loaded on virtually any computer device.

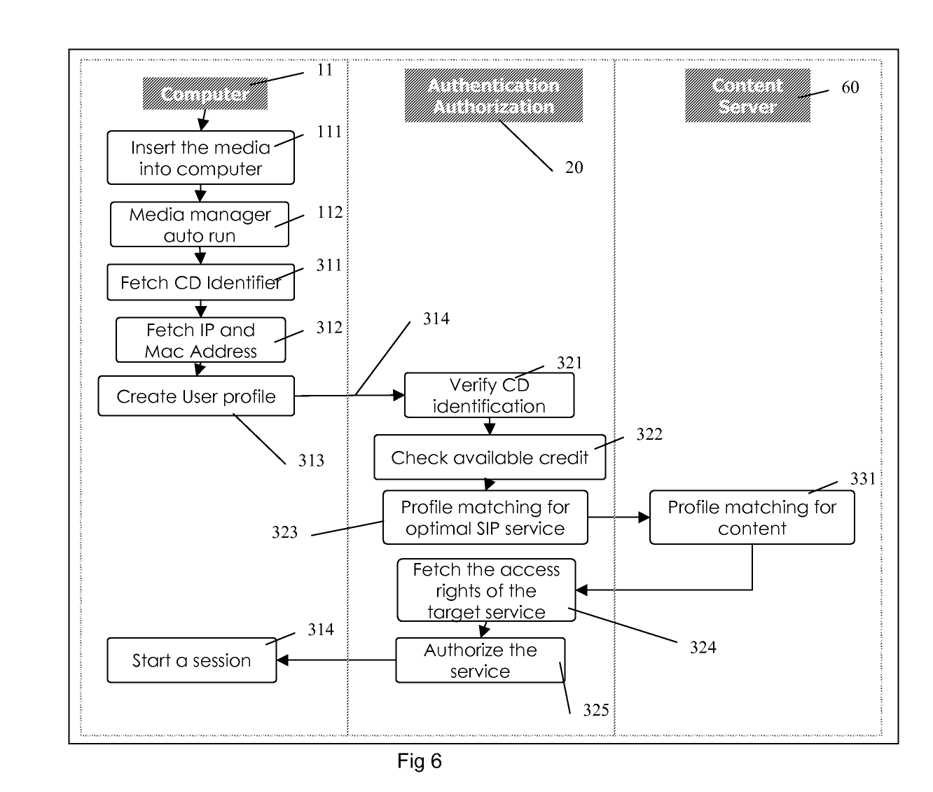

FIG. 6 is a flow diagram that depicts the authorization, authentication and service selection process of an embodiment of the invention. In this flow diagram computer device 11 has removable memory media inserted into the computer 111, as also shown in FIG. 2. Once again the media manager on the removable media initiates auto run 112. Upon the initiation of auto run 112 the software, loads any static content, opens a GUI for the computer 11, and finds the identification of the particular media inserted into the computer 111.

The software resident on the media next finds location information of the computer the media is inserted into. This would be the IP address and MAC address 312 With the collected information the software creates a user profile which can include the collected information and any other data about the particular user that is desired such as media identification (ID of the CD), time stamp, duration of connection, frequency of use, operating system, browser versions and the like. Once the information is collected as a packet or packets of information it is sent 314 to the authentication server 20 by the computer device 11.

Upon receipt of the user profile 313 from the computer device 11 the authentication server 20 verifies the media identifier 321 matching the user profile with the media. The authentication server 20 then checks available credit 322 corresponding to the media identifier in order to determine the amount of connect time available on that media. If credit is available for that media the Authentication server 20 takes the created user profile 313 and matches information on the profile to the available SIP services 323 that could be used by the computer device 11. Location determined from the computer address could be used to find the closest SIP service or the service with the strongest signal or the least expensive from the location. If other profile data is collected that also could be used in matching for the optimal SIP service 323.

The authentication server 20 can also use the profile matching process (either before or after selection of the SIP service) to contact the content server 60. The content server then takes the user profile and matches available dynamic content to be sent to the computer device 11. The location can be used to send local dynamic content. Also, phone numbers called can be used to determine which content to select. Likewise, any other user profile characteristic that is collected used to select dynamic content. Where no particular match occurs, the dynamic content matched can be of a random selection such as a general advertisement or the like.

Once the matching content is selected 331 by the content server 60 it is sent back to the authentication server 20 and the access rights to the SIP service 324 is combined with the content. The Authentication server 20 then authorizes the service 325 by sending the access rights and dynamic content to the computer 11 which allows a customer on the computer 11 to start a session 314 with the SIP service.

While the figures above and the descriptions herein are illustrative of particular embodiments of the invention it is evident, based on the teachings herein that there are alternatives, modifications, permutations and variations of the embodiments which are within the contemplated scope of the invention and would be apparent to those of skill in the art in light of the disclosure herein. Accordingly the embodiments should not be considered as limiting the following claims.

What is claimed is:

1. A system enabling a customer to initiate internet media communication and interact with selected static or dynamic multimedia content over any computer device comprising:
a. a removable memory media comprising multimedia communication software and a media identification code wherein the software is capable of self executing, self configuring and sending the media identification code to a selected authentication server;
b. an authentication server capable of identifying the media identification code, profile matching the computer device and selecting a communication service provider for that location, wherein the authentication server is capable of sending the computer device authorization to engage in a communication event with the selected provider;
c. a session controller capable of initializing, monitoring, and controlling the communication event by the customer; and
d. a means for presenting the customer multimedia content on a graphic interface on the computer device from the group consisting of static content and dynamic content.

2. A system according to claim 1 wherein profile matching is selected from the group consisting of location identification, customer preferences and customer attributes.

3. A system according to claim 2 wherein location identification consists of identifying the IP address of the computer device.

4. A system according to claim 2 wherein the customer preferences and customer attributes are determined by monitoring the customer activity on the computer device.

5. A system according to claim 2 wherein the customer preferences and customer attributes are determined by collection of data from the customer.

6. A system according to claim 1 wherein a content server provides dynamic content to the computer device.

7. A system according to claim 6 wherein the dynamic content is selected to be provided to the computer device based on the profile matching.

8. A system according to claim 1 wherein the removable memory media further comprises resident static content.

9. A system according to claim 1 wherein the internet media communication is selected from the group comprising internet telephony, instant messaging and video conferencing.

10. A system according to claim 1 wherein the authentication server comprises a database for storage of information.

11. A system according to claim 1 wherein a session server monitors a predetermined parameter for communication with the communication service provider and terminates the communication when the parameter is exceeded.

12. A system according to claim 11 wherein the parameter is time.

13. A system according to claim 1 wherein the software opens a content page having at least one page of static content and another page displaying a graphic user interface for initiating a communication event.

14. A system according to claim 13 wherein the software opens static content on the page displaying a graphic user interface for initiating a communication event.

15. A system according to claim 6 wherein the content server can replace the content being viewed by the customer on the computer device with dynamic content.

16. A system according to claim 1 comprising a content server, an authentication server and a session controller.

17. A system according to claim 1 wherein the communication service provider is chosen based on a parameter selected from the group consisting of: distance from the computer device, cost of the service from the provider, and quality of the available providers.

18. A system according to claim 1 wherein the communication provided by a service provider is over a PSTN.

19. A system according to claim 1 wherein the removable storage media is an easy to remove media storage device.

20. A system according to claim 1 wherein dynamic content is provided to the computer device based on customer activity on a content page on the computer device.
